(19) United States
(12) Patent Application Publication
(10) Pub. No.: US 2007/0038487 A1
(43) Pub. Date: Feb. 15, 2007

(54) Senior assisted living eligibility system

(76) Inventor: William K. McCarthy, Hudson, OH (US)

Correspondence Address: ROETZEL AND ANDRESS, 222 SOUTH MAIN STREET, AKRON, OH, 44308, US

(21) Appl. No.: 11/504,451

(22) Filed: Aug. 15, 2006

Related U.S. Application Data
(60) Provisional application No. 60/708,281, filed on Aug. 15, 2005.

(51) Int. Cl. G06Q 40/00

(52) U.S. Cl. 705/4

(57) ABSTRACT

A computer assisted method of evaluating the availability and eligibility for benefits for individuals, such as senior citizens and persons in assisted living facilities, including the steps of gathering appropriate information about background, military history, finances, financial status, health status, heath care needs, personal history and personal information related to potential applicants for benefits, inputting the information into a computer data base, analyzing the information gathered, using a computer, by comparing the information gathered, the needs of the individuals and the requirements needed to qualify for benefits, evaluating if a need for benefits exists, and determining the benefits available.

### BACKGROUND OF THE INVENTION

The present invention is directed to systems and processes for managing and determining the eligibility of and securing, supplemental retirement benefits for retirees or persons near retirement age.

Many individuals when they retire are provided with a fixed retirement income from Social Security, their pension(s), their savings, or combinations of these. This is their primary source of retirement income. A difficulty with fixed income occurs when needs arise, perhaps later in retirement, for example, for living in an assistant living facility. People find it difficult to locate additional sources of income to pay for their additional care. Often, the complexities and esoteric nature of the additional sources of retirement benefits, such as veterans benefits, medicaid benefits, and the like, which can be viewed as supplemental retirement benefits, make it difficult for many individuals to sort through the issues and identify elegibility requirements to supplement their retirement benefit income streams.

### SUMMARY OF THE INVENTION

The present invention is directed to a system and process for quickly, conveniently, and consistently locating, evaluating, determining the eligibility for, applying for, managing and securing supplemental retirement benefits for seniors by analyzing the finances and needs of potential applicants to determine eligibility based upon input from those applicants and health care officials, performing an analysis of specific retirement benefits to ascertain qualification and availability, and ultimately, to securing the benefits. The benefits could include, but are not limited to, benefits from the Veterans Administration, benefits from Medicaid, and the like.

### BRIEF DESCRIPTION OF THE DRAWINGS

FIG. 1 is a flow chart showing the process of the present invention.

FIG. 2 is an assessment form for use in accordance with the present invention.

FIG. 3 is a schematic flow diagram showing an example of an analysis for eligibility of supplemental retirement benefits.

### DETAILED DESCRIPTION OF THE INVENTION

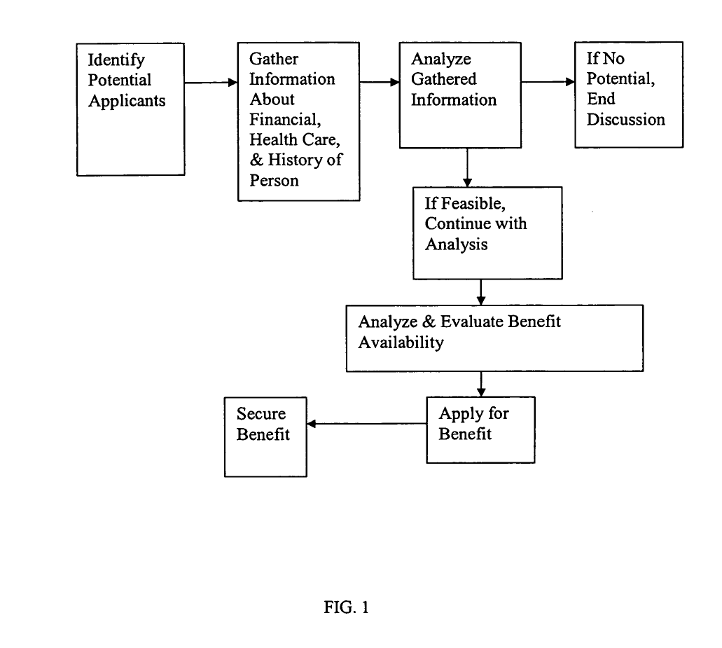

The present invention is directed to a system and process for managing and securing potential supplemental benefits for persons that are retired or near retirement age. The process involves the steps of quickly, conveniently, and consistently identifying potential applicants, gathering information about the person and their history, their finances, their health care needs, determining feasibility of obtaining benefits, analyzing the finances, health care needs of, and history and information about potential applicants or persons to determine the potential eligibility of governmental benefits. The process facilitates remote or web accessibility. This process is summarized in FIG. 1.

Input from the applicants is crucial to being able to perform an effective analysis to identify financial need. Gathering all the information necessary to make a full evaluation, avoids having to gather additional information during the benefit evaluation. By comparing the financial needs and the financial analysis a determination can be made as to whether it is feasible or necessary to apply for supplemental retirement benefits, in addition to any primary retirement sources of income. If such a need exists, then it is necessary to identify and evaluate supplemental retirement benefits which can provide the maximum additional income. By using the information developed as part of the financial analysis, an analysis can be made to determine if benefits may be available and the applicant is qualified to receive such benefits.

The potential applicants can be identified by contacting extended health care facilities, including assisted living facilities, nursing homes and the like. A survey of the residents and patients in such facilities will identify potential applicants, as will working with health care officials and institutions to educate individuals about their health care and benefits, along with the health care and benefits of those in their families that would have similar needs.

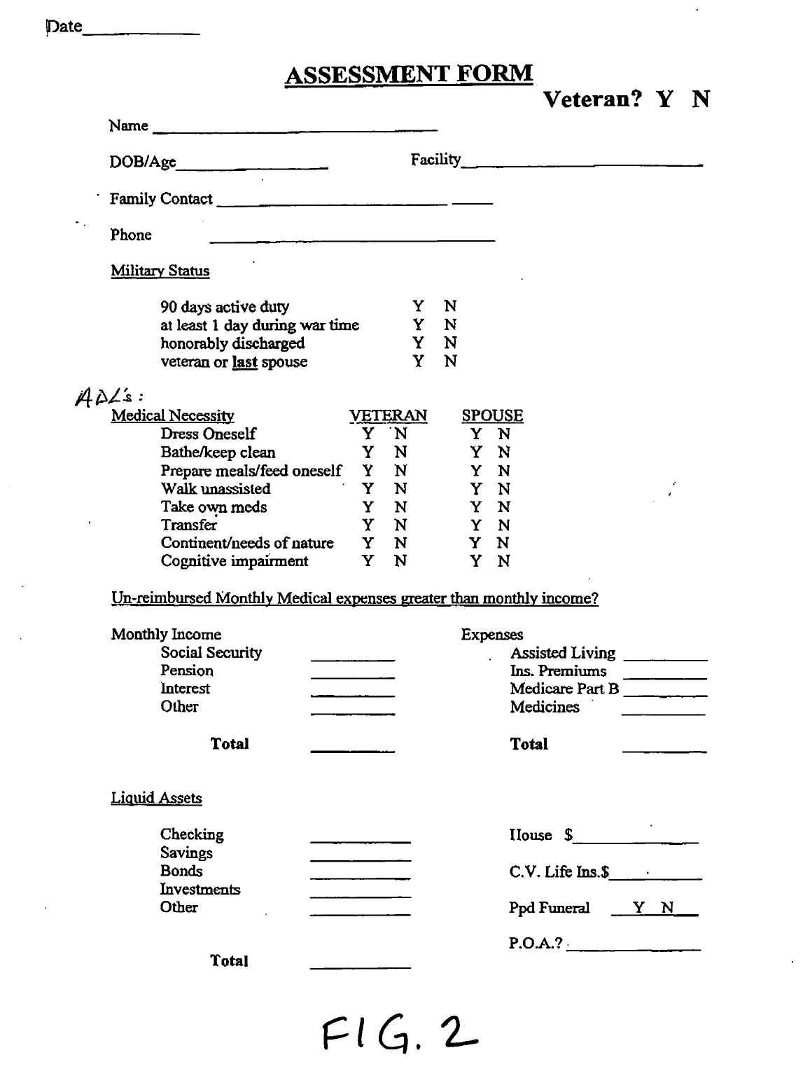

The appropriate information can be gathered on an appropriate form or checklist, such as the Assessment Form illustrated in FIG. 2, and would include the activities of daily living (ADL's) and the following:
1.) Personal Information, including:
   a.) Name?
   b.) Date of Birth?
   c.) Address?
      i.) Assisted Living Facility?
      ii.) Level of Care?
      iii.) Family Contact Information?
   d.) Marital Status
      i.) Current Status?
      ii.) Prior Marriages?
      iii.) Marriage Certificate(s)?
      iv.) Divorce paper(s)?
      v.) Death certificate(s)?
2.) Doctor(s) information:
   a.) Name?
   b.) Address?
   c.) Telephone and other contact information?
   d.) Brief Health History?
   e.) Ability to perform ADLs?
   f.) Prescriptions
   g.) Power of Attorney for Health Care?
   h.) Guardian?
3.) Military History:
   a.) Veteran?
   b.) Spouse of Veteran?
   c.) Facility letter & VA Form?
   b.) Military Discharge papers?
4.) Financial History and Information:
   a.) Proof of Social Security income(s)?
   b.) Proof of pension(s)?
   c.) Proof of “other income” (interest, dividends, etc.)?
   d.) Proof of medical expenses?
   e.) Medicare Part B?
   f.) Medical Supplemental Insurance Premiums?
   g.) Power of Attorney?
   g.) Out of pocket expenses (Depends, dental, etc.)?
   h.) Proof of assets?
   i.) Bank statements?
   j.) Brokerage accounts?
   k.) Investments?
   l.) Cash value of life insurance?
   m.) Prepaid funeral expenses?
   n.) Market value of home?
      i.) Current Mortgage?
5.) Other/Miscellaneous Information?

This information is the minimum, and therefore appropriate, amount of information needed to be able to perform the analysis for the benefit analysis, but other information, conveniently, might be gathered as well. Since the information gathered will provide a financial and personal picture of the individual, a good understanding of the individual will facilitate the overall financial counseling of the individual.

The information can be gathered by hand such as by having a potential applicant or their representative fill out a written questionnaire or orally via an interview process with the interviewer filling out the questionnaire. It is preferred that the information be gathered and entered directly into a questionnaire that is part of the computer assisted element of this process. Since part of the program is the presentation of a series of screens which present the information needs and thus the questionnaire. In this way, the information can be quickly and conveniently gathered and can be easily printed in summary form. Further, the information can be remotely accessed by other persons that may be part of the process. The remote access is facilitated by maintaining a remotely accessible web site, which with appropriate pass word protection, allows for a secure access site to review the gathered information, results, and print the results.

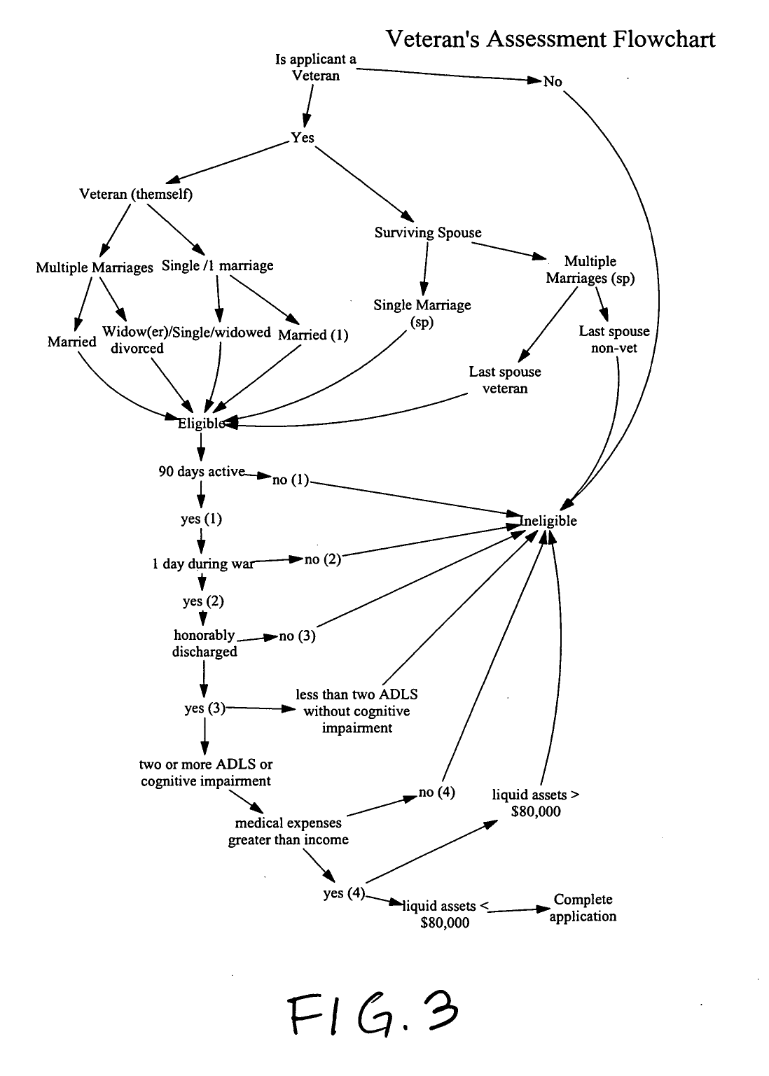

By inputting the criteria for eligibility for the benefits, a comparison can be made between the information inputted and the criteria and a determination can be made about eligibility. Once the opportunity for supplemental benefits appears feasible, an analysis for the benefit is then performed. For example, although not wishing to be limited to the example, if one of the possible benefits involves benefits available from the Veterans Administration, an assessment can be made in accordance with the flow charts set forth in FIG. 3. Such an analysis can be automated and performed quickly, for example, using a program based on the Microsoft Access system and using a desktop personal computer. This is beneficial in providing and performing an analysis, given the fact that many of the individuals that would qualify as applicants have growing difficulty in following and paying attention to the analytical process. An automated system can perform the analysis quickly and facilitate assisting the individual in understanding their eligibility for the supplemental benefits and the impact on their lives through enhanced health care benefits.

As can be seen from FIG. 3, there are many complexities involved in the sorting process. The information developed during a financial analysis of a potential applicant provides the basis for performing the assessment. If the assessment leads to the determining of eligibility of supplemental benefits, then the next step will be the completion and filing of the application for and securing of the benefits. The success in securing additional retirement benefits can make a tremendous difference in whether or not a senior may be able to afford the health care they require.

Once the analysis is done, it is simply a matter of the individual applicant, or someone acting on their behalf, applying for and securing the identified potential benefits.

Thus the process of the present invention takes into account and anticipates the information needed to lead to a positive conclusion. By automating the process, the complex evaluation process is accelerated, consistent, convenient, and the errors are minimized.

Various modifications and alterations that do not depart from the scope and spirit of this invention will become apparent to those skilled in the art. This invention is not to be duly limited to the illustrative embodiments set forth herein.

What I claim is:

1. A computer assisted method of evaluating the availability and eligibility for benefits for individuals, such as senior citizens and persons in assisted living facilities, comprising:
A. gathering appropriate information about background, military history, finances, financial status, health status, heath care needs, personal history and personal information related to potential applicants for benefits,
B. inputting the information into a computer data base,
C. analyzing the information gathered, using a computer, by comparing the information gathered, the needs of the individuals and the requirements needed to qualify for benefits,
D. evaluating if a need for benefits exists, and
E. determining the benefits available.

2. The method of claim 1 including the further step of applying for the benefits to thereby secure additional benefits for qualified individuals.

4. The method of claim 1 wherein the benefits are Medicaid benefits.

5. The method of claim 1 wherein the benefits are Veterans Administration benefits.

6. The method of claim 1 wherein the evaluation is made using automated processing.

7. The method of claim 1 wherein the gathering is done using a predetermined questionnaire.

8. The method of claim 1 wherein the gathering is done by an oral evaluation and using a predetermined informational checklist.
